(19) United States
(12) Patent Application Publication
(10) Pub. No.: US 2008/0023331 A1
(43) Pub. Date: Jan. 31, 2008

(54) Electrophoretic Chip, Electrophoretic Device and Electrophoresis Method

(75) Inventor: Wataru Hattori, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/570,668

(22) PCT Filed: Jun. 15, 2005
(86) PCT No.: PCT/JP05/10975

§ 371 Date: Dec. 14, 2006

(30) Foreign Application Priority Data
Jun. 15, 2004 (JP) 2004-177574

(51) Int. Cl. B01D 57/02

(52) U.S. Cl. 204/451; 204/450; 204/600; 204/601

(57) ABSTRACT

Liquid-keeping part is formed in channel 107 of chip 111 for electrophoresis. Electrophoresis is carded out by using electrophoresis chamber 118 holding chip 111 for electrophoresis in its inside and having a system of controlling temperature of electrophoretic chip 111 by putting humidity-controlling liquid 117.

### TECHNICAL FIELD

The present invention relates to an electrophoretic chip, an electrophoretic device and an electrophoresis method, which use the chip.

### BACKGROUND ART

In recent years, with the progress in microelectro-mechanical system (MEMS) technique, an analytical system has been intensively developed. In such analytical system, a protein or a DNA included in a sample solution is separated in a channel formed in a microchip for liquid electrophoresis. The sample thus separated is analyzed by an electrospray ionization mass spectrometer coupled on-line with the chip. However, development of a chip or an interface has been not progressed, which can be coupled on-line with a matrix-assisted laser desorption/ionization mass spectrometer (MALDI-MS) MALDI-MS is also another representative means for determination of protein. The reason is that, in the case of MALDI-MS, it is necessary to dry and crystallize the sample together with the matrix, while a liquid sample solution is treated in the chip, especially the electrophoresis process. It is difficult to carry out a drying process sequentially after the electrophoresis in the chip. In order to solve this problem, Non-Patent Literature No. 1 discloses a system that achieved the approximately same level of convenience as the on-line coupling system. In this system, using a chip which has the interface accessible easily to MALDI-MS, the whole analysis process, which constructed by a sample separation and MALDI-MS analysis, is carried out in the chip.

Non-Patent Literature No. 1 describes a method. This method includes the steps:

separating a matrix-containing sample in a non-sealed groove channel on a chip. The non-sealed groove channel means that the channel surface is open or uncovered;

drying the solvent in the channel to crystallize and fix the sample thus separated on the channel; and

scanning a laser along the channel to subject the separated-sample to laser desorption/ionization for mass spectrometry using MALDI-MS.

Regarding the technique disclosed in Non-Patent Literature No. 1, the size of the channel is 250 μm or 200 μm as depth, and 250 μm or 150 μm as width. This size is larger as compared with the channel size of the chip coupled to ESI-MS, in which the channel is ordinarily 100 μm or less as diameter.
Non-Patent Literature No. 1:
   Jun Liu, Ken Tseng, Ben Garcia, Carlito B. Lebrillia, Eric Mukerjee, Scott Collins, and Rosemary Smith, “Electrophoresis Separation in Open Microchannels. A Method for Coupling Electrophoresis with MALDI-MS”, Analytical Chemistry, Vol. 73 (2001), No. 9, pp. 2147-2151

### DISCLOSURE OF THE INVENTION

### OBJECTS TO BE ACHIEVED BY THE INVENTION

It is known that the sensitivity of MALDI-MS is almost in the range from amol to pmol, which is high in comparison with that of ESI-MS. Therefore, a channel having a large sectional area such as that in Non-Patent Literature is principally not necessary for preparation of a sample, which is provided to MALDI-MS.

However, when the sectional area decreases in such chip, the solvent in the channel easily vaporizes in an ordinary room or under the control by water cooling of Non-Patent Literature alone. Thus, the channel cannot be stably filled with the sample solution. In particular, regarding the application to MALDI-MS, in which the diameter of the laser is about 100 μm, if the channel width is set less than the laser spot diameter, the effective area of laser irradiation to ionize the sample decreases and its efficiency lowers.

It is considered to make the depth of the channel small in order to decrease the sectional area of the channel. However, when the depth of the channel becomes smaller, its surface area related to solvent vaporization relatively increases in comparison with the channel volume. Additionally, when the depth of the channel is smaller, it becomes difficult to keep the liquid in the channel by gravitation alone. Thus, the liquid can easily over flow from the channel. Also, when the length of the channel was enlarged to improve its separation ability under the condition that the sample volume was fixed, the surface area, from which the solvent vaporized, increased and, thus, it was difficult to keep the solution in the channel.

As described in Non-Patent literature No. 1, the sample solution vaporized by temperature rise caused by Joule heat. Further, a problem still remains for improvement with respect to the stable contact of an electrode(s) with the liquid.

As noted above, when the sample separation applied to MALDI-MS is carried out by electrophoresis and the miniaturization of the channel becomes a factor against the stable separation. As a result, the conventional method as noted above could not respond to the problem for compatibility between the separation of desired component in a very small-amount sample by electrophoresis and the analysis by MALDI-MS. Therefore, a method different from the conventional one has been required.

The present invention has been made in view of the above situation. The object of the present invention is to provide a technique for stable electrophoresis for a small amount of a sample.

### MEANS FOR ACHIEVING THE OBJECTS

An electrophoretic chip of the present invention is characterized by:

comprising a substrate and a channel formed, on the substrate, for electrophoresis of a sample;

said channel having an open part, the top part of which is open or uncovered, and a liquid-keeping part on the bottom part of the channel, on which bottom part a large number of pillars are arranged regularly;

said liquid-keeping part being formed in the open part, the open state of which is maintained during electrophoresis in a electrophoresis chamber or near the open part.

An electrophoretic device of the present invention is characterized by comprising:

an electrophoresis chamber, in which an electrophoretic chip having the above-mentioned structure is set; and

a humidity-controlling means for controlling the humidity inside the electrophoresis chamber.

An electrophoresis method of the present invention is an electrophoresis method for electrophoresis of a sample using an electrophoretic device having the above-mentioned structure. The electrophoresis method is characterized by comprising the steps of:

placing said electrophoretic chip in the electrophoresis chamber of said electrophoretic device;

controlling the humidity inside the electrophoresis chamber by said humidity-controlling means;

introducing a sample into said channel; and

applying a voltage to said channel to conduct electrophoresis for the sample.

### EFFECT OF THE INVENTION

As described above, the present invention realizes a technique for stable electrophoresis of a very small amount of a sample, by using an electrophoretic device. This device comprises an electrophoretic chip, in which a channel has a liquid-keeping part of a regularly arranged pillar array structure, and a means for humidity-control.

### BRIEF DESCRIPTION OF THE DRAWINGS

FIG. 1 is a plan view schematically showing the structure of an electrophoretic chip according to the embodiment 1 of the present invention.

FIG. 2 is a sectional view taken at the A-A′ line of FIG. 1.

FIG. 3 is a sectional view schematically showing the structure of an electrophoretic device according to the embodiment 1 of the present invention.

FIG. 4 shows the humidity change in the electrophoresis chamber of an electrophoretic device according to the embodiment 1 of the present invention.

FIG. 5 is a photograph as a plan view of an electrophoretic chip according to Example 1.

FIG. 6 is a sectional view schematically showing the structure of the channel of an electrophoretic chip according to Example 1.

FIG. 7 is a plan view (a photograph taken by a scanning type electron microscope) of the channel of an electrophoretic chip according to Example 1.

FIG. 8 is a perspective view (a photograph taken by a scanning type electron microscope) of the channel of an electrophoretic chip according to Example 1.

FIG. 9 is a sectional view schematically showing the structure of an electrophoretic device according to Example 1.

FIG. 10 shows an electrophoretic chip according to the embodiment 2 of the present invention.

FIG. 11 is a sectional view schematically showing the structure of an electrophoretic device according to the embodiment 2 of the present invention.

### EXPLANATION OF SYMBOLS

100: Electrophoretic chip

101: Substrate

102: First pillar array structure

103: Lyophilic layer

104: Flat part

105: Second pillar array structure

106: Lyophobic layer

107: Channel

108: Liquid-keeping part

109: Liquid-phobic part

110: Electrophoretic device

111: Electrophoretic chip

112: Mount

113: Cooling-heating system

114: Supporting plate

115: Thermosensor

116: Temperature controller

117: Humidity-controlling liquid

118: Electrophoresis chamber

119: Cooling-heating system

120: Mount

121: Thermosensor

122: Temperature controller

123: Heat-insulating container

124: Inner lid

125: Outer lid

126: Capillary

127: Electrode

128: Voltage source

129: Fluororesin coating

130: Screw

131: Fan

132: Heat-conductive gel sheet

140: Electrophoretic chip

141: Channel

142: Reservoir

143: Reservoir

144: Bottleneck

145: Bottleneck

146: Reservoir

147: Thin titanium layer

148: Thin gold layer

150: Electrophoretic device

161: Through-hole

162: Humidity-controlling liquid chamber

183: Chip-installed chamber

201, 202: Channels provided for vapor pressure control

203, 204: Reservoirs for holding of volatile solvent

205, 206: Reservoirs for holding of electrode solution

207, 208: Salt bridges

209, 210: Parts for introduction of sample-containing solution

211: Glass lid

212: Plate for liquid cooling

213: Hole for cooling liquid-circulating pipe

214: Packing

215: Gas outlet

216: Gas inlet

### BEST MODE FOR CARRYING OUT THE INVENTION

The electrophoretic chip according to the present invention comprises a substrate and a channel for electrophoresis of a sample. The channel is formed on the surface of the substrate. The bottom part of the channel has a liquid-keeping part having a large number of pillars arranged regularly. The channel has a structure having an open part(s), of which the upper side is uncovered, when the chip is set in an electrophoretic device and electrophoresis is conducted.

In the electrophoretic chip of the present invention, a liquid-keeping part is formed, which comprises the first pillar array structure. In the first pillar array structure, a large number of pillars arranged regularly, which project form the bottom part of the channel. Since the first pillar array structure is formed, the liquid-keeping ability can be increased in comparison with the case using a flat surface in the channel. In other words, an apparent lyophilicity, i.e., an apparent affinity to the liquid, can be improved. Therefore, such a channel can hold a sample-containing liquid stably in the liquid-keeping part. Also, in the chip of this structure, heat exchange takes place between the electrophoretic chip and the liquid introduced into the channel, via the surface of the first pillar array structure. Therefore, in the electrophoretic chip of the present invention, the temperature rise of the sample-containing liquid in the channel can be moderated. This temperature rise resulted from the Joule heat during electrophoresis. The moderation of the temperature rise makes possible stable electrophoresis. The first pillar array structure can be formed so as to have a lyophilic surface, i.e., a surface having affinity to the liquid.

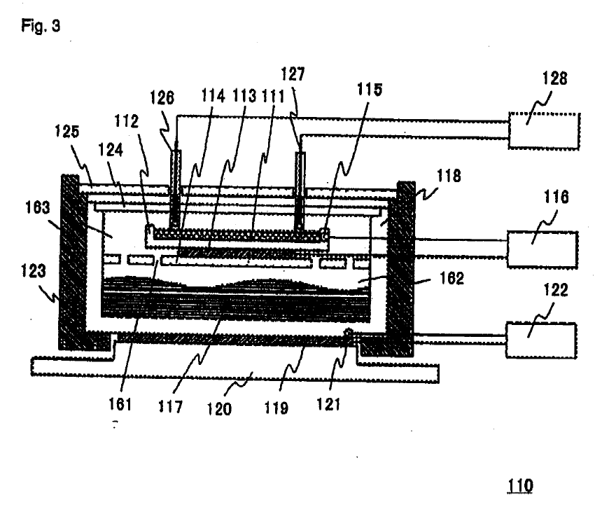

According to the present invention, the channel has a structure, which comprises a bottom depressed from the top surface of the substrate; and side walls. At least a top part has a structure open to out side, when electrophoresis is conducted in an electrophoresis chamber. For example, the chip is formed so that the channel has an open part(s) so that the capillary (described later) (see FIG. 3) or the reservoirs (described later) (see FIG. 11) are set. When the open part can be formed in the channel partially, the open part(s) can be made by covering the top part(s) of the channel by a cover or the like. Therefore, the top part of the channel may be entirely or partially open. Although the channel has the open part(s), the liquid containing a sample can be kept reliably in the channel by forming the liquid-keeping part in the channel. Thus, a structure to make stable electrophoresis possible is formed.

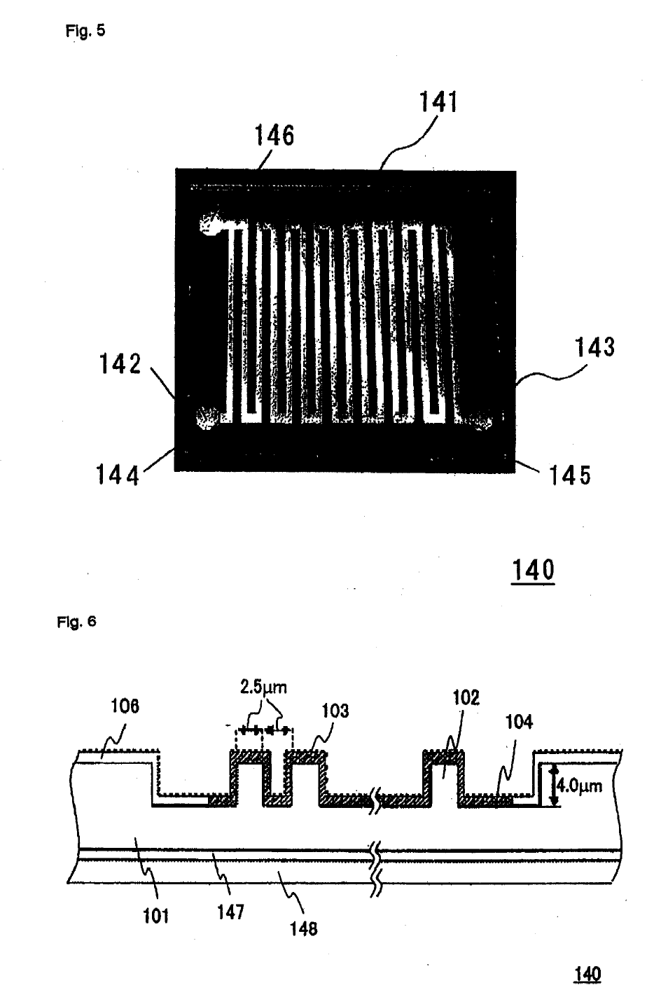

It is preferred that the liquid-keeping part is formed inside or near the part which receives a sample-containing liquid provided to the channel. The liquid-receiving part is those shown in FIG. 3 to which the bottom of the capillary is set or shown in FIG. 11 to which the reservoirs are set. The sample-containing liquid thus provided can be rapidly distributed and kept in the channel by forming the liquid keeping part at such position. It is also preferred to form the receiving part as a liquid keeping part consisting of an area broader than the channel for electrophoresis and surrounding the area by a flat part having no pillar array structure. For example, a liquid-keeping part wider than the channel for liquid introduction is formed at each of positions (channel ends) where the reservoir of FIG. 5 or the reservoirs 205 and 208 of FIG. 11 are placed. In addition, a flat part is formed at the periphery of the liquid-keeping part. When a liquid-keeping part extends from each channel end to the center of the channel, this liquid-keeping part is excluded from the area to be formed as a flat surface. As a result, the smooth supply of the sample-containing liquid into the channel can be carried out.

The channel may be formed as a groove on the surface of the substrate, The whole bottom of the channel may be a liquid-keeping part.

In the present invention, the channel is formed so as to comprise a liquid-keeping part having a regularly-arranged pillar array structure. Therefore, it is impossible to produce the channel simply by roughening the surface of the substrate. This point is described later. The regularly-arranged pillar array structure means that the shape, configuration, etc. of the pillar array structure are formed with a regularity and the structure is not random.

The entire area used for electrophoresis in the channel, for example, almost the entire surface in the channel may be formed as the liquid keeping part comprising the first pillar array structure. When a channel extending linearly between both end points is used, a liquid-keeping part may be formed from the vicinity of one end of the channel to the vicinity of other end.

Preferably, the liquid-keeping part is formed so as to satisfy |αcosθ|>1, wherein αcosθ is the product of the ratio a of the surface area of the liquid-keeping part to the area occupied by the liquid-keeping part; and the contact angle θ of a sample-containing liquid to the flat surface having the same surface condition as the liquid-keeping part.

Since the liquid-keeping part is formed so as to satisfy the above formula, the sample-containing liquid can fill the liquid-keeping part uniformly without being split into liquid droplets. Thereby, the sample-containing liquid can be kept stably in the channel. In the present invention, the flat part may be made of the same material as that for the first pillar array structure.

In the electrophoretic chip of the present invention, the liquid-keeping part may have a structure, in which a plurality of rows is arranged in parallel. Each row may consist of a plurality of truncated cones or pyramids in almost the same shape, as a pillar shape structure. Each row may be arranged regularly along the extending direction of the channel. Thereby, the liquid-keeping part can have a simple structure and a sufficient large surface area in comparison with the flat liquid-keeping part. Further, the first pillar array structure may be a structure which is suitable for production by etching or embossing.

In the present invention, “a plurality of truncated cones or pyramids in almost the same shape” means that the identity of each pillar shape can be so kept, i.e., the shapes of the pillars can be so identically or similarly kept that the liquid is reliably kept in the liquid-keeping part and that the liquid dose not leak from the particular positions.

In the electrophoretic chip of the present invention, the height of each pillar shape structure and the depth of the channel may be made almost the same, including the case that the height and the depth are the same, or substantially the same in order to obtain the effects in the present invention. The channel and the first pillar array structure can be formed in one process using a technique such as dry etching or the like. In the present invention, the height of each pillar shape structure and the depth of the channel may be slightly different from each other as long as the channel and the first pillar array structure can be formed in one process.

In the electrophoretic chip of the present invention, the bottom surface, or at least one part of the side wall in the first pillar array structure may be made more lyophilic in comparison with the upper surface of each pillar shape structure. As a result, the sample-containing liquid can be reliably kept in the portions which have been made lyophilic. In addition, a high trapping effect can be obtained. Therefore, the leakage of the sample-containing liquid from the liquid-keeping part can be prevented reliably. In addition, when the surface of the substrate is lyophobic (i.e., it has no or low affinity to the liquid), the sample-containing liquid can be kept by making at least the bottom part and a part of the side wall in the first pillar array structure lyophilic.

In the electrophoretic chip of the present invention, the upper surface and at least a part of the side wall in each pillar shape structure may be made more lyophobic in comparison with the lower surface of the first pillar array structure. As a result, the lower surface and part of the side wall in the first pillar array structure can be made lyophilic selectively. Therefore, a high trapping effect for the sample-containing liquid is obtained, and the leakage of the sample-containing liquid into outside the channel can be prevented. In particular, the leakage of the sample-containing liquid from the open part of the channel can be prevented. Such structure can be easily produced, for example, by forming a lyophobic film on a lyophilic substrate; and then subjecting both the lyophobic film and the substrate to a single process such as etching (e.g. dry etching using a resist film). Thus, a first pillar array structure can be formed. As a result, the upper surface of each pillar shape structure can be made lyophobic by the lyophobic film. The upper area of each side wall of the pillar shape structures can be lyophobic by the sectional area of the lyophobic film. In addition, the bottom surface and the lower area of the side wall can be lyophilic by the lyophilic substrate.

The electrophoretic chip of the present invention may be formed so as to have a lyophobic part comprising a second pillar array structure, which has a large number of pillars from the bottom. The lyophobic part may be formed outside of the liquid keeping part at the bottom surface in the channel, but adjacent to the liquid keeping part. As a result, the sample-containing liquid can be trapped inside the liquid-keeping part more reliably, by forming the lyophobic part having a second pillar array structure in the channel. Thus, the sample-containing liquid can be kept in the channel more stably. Further, such structure is excellent regarding easy production. Such structure can be produced, for example as follows: A pillar array structure in a groove-shaped channel is formed. Then, if he surface of the pillar array structure is lyophobic, a part of the structure is covered by a lyophilic coating. If the surface of the pillar array structure is lyophilic, a part of the structure can be made lyophobic by applying a lyophobic coating. Thus, the above structure can be obtained.

The electrophoretic chip of the present invention may have a flat part adjacent to the liquid-keeping part. The flat part may be provided so as to surround the liquid-keeping part. Thereby, in the flat part having no pillar array structure, the sample-containing liquid forms droplets and does not spread. Therefore, the liquid is kept in the liquid-keeping part more reliably. Although the liquid leaks to the outside of the first pillar array structure, the liquid can be stopped in the flat part. Also, since the first pillar array structure is made more lyophilic than the flat part, the liquid can be returned into the first pillar array part. Therefore, the sample-containing liquid can be kept in the channel reliably and the leakage of the liquid out of the channel can be prevented.

The electrophoretic chip of the present invention may have a structure, in which a lyophobic part having a second pillar array structure is formed, so as to surround the periphery of the above-mentioned flat part. Thereby, even when the sample-containing liquid leaks out of the flat part, the sample-containing liquid can be reliably stopped in the lyophobic part. The lyophobic part has a surface which is made more lyophobic than the flat part. This lyophobic part may be located in the liquid-keeping part via the above-mentioned flat part. Preferably, a liquid-keeping part, a flat part and a lyophobic part may be located in this order, from the center of the channel toward the side of the channel. Such structure can be produced stably using a micro-processing technique. For example, when a coating is applied on the surface of the electrophoretic chip to form a channel, the flat part can be used as a margin for adjustment of the coating area.

The electrophoretic chip of the present invention may be formed so as to be used in an electrophoresis chamber having a humidity-controlling ability. Thereby, the vaporization of the liquid introduced into the channel can be prevented more reliably.

The present invention provides an electrophoretic device characterized by having an electrophoresis chamber and a humidity-controlling means for controlling the humidity inside the electrophoresis chamber. The above-mentioned electrophoretic chip is put in the chamber.

The electrophoretic chip is placed in the electrophoretic device of the present invention, in a state that at least a part of the top side of the channel is open. Also, a humidity-controlling means is installed in the electrophoretic device of the present invention. As a result, when the electrophoretic chip is set in the electrophoresis chamber, the humidity of the solvent of the sample-containing liquid or the other liquid in the electrophoresis chamber can be kept at a sufficiently high level, which is not higher than the saturated vapor pressure of the solvent or the other liquid. Thus, the vaporization of the solvent in the channel during electrophoresis can be prevented.

The electrophoretic device of the present invention may have a structure in which the humidity-controlling means may be installed inside the electrophoresis chamber to be filled by a humidity-controlling liquid. Also, in the present invention, the humidity-controlling liquid may be the solvent used in the sample-containing liquid, or the other liquid having the same function as the solvent. Thereby, the inside of the electrophoresis chamber can be filled with the saturated vapor of the humidity-controlling liquid. As a result, although the upper side of the channel, i.e., the top side of the channel, is partially or entirely open, the humidity of the atmosphere near the open part can be kept at a sufficiently high level. Thereby, the vaporization of the liquid inside the channel during electrophoresis can be prevented.

In the electrophoretic device of the present invention, a temperature-controlling means for the electrophoretic chip and a temperature-controlling means for the humidity-controlling liquid chamber may be installed. Thereby, the saturated vapor pressure of the humidity-controlling liquid generated from the humidity-controlling chamber and the saturated vapor pressure of the liquid kept in the channel can be controlled independently from each other. Also, the temperature rise of the sample-containing liquid, which is caused by the Joule heat generated during electrophoresis, can be prevented.

In the electrophoretic device of the present invention, capillaries for supplying the sample-containing liquid to the channel may be set. The capillaries preferably have a structure which enables the insertion of an electrode for voltage application to the channel. In this case, the electrophoretic device is formed so that the sample-supplying tip of capillary can be provided at a predetermined site of the channel of the electrophoretic chip. By setting the capillaries, a sample-containing liquid or an electrode solution can be introduced into the channel in a state that the electrophoresis chamber has been sealed or almost sealed. Further, the contact of the electrode with the solution can be reliably secured simply by inserting an electrode into the capillary, when the electrode solution also in each capillary is present in a state that the electrode solution is in contact with the channel. Furthermore, under such condition, the surface level of the sample-containing liquid in the channel can be kept at a given level when the sample-containing liquid is charged into in the channel.

The present invention provides an electrophoresis method for conducting electrophoresis for a sample using the electrophoretic device formed as above, which is characterized by comprising the steps:

placing said electrophoretic chip in the electrophoresis chamber of said electrophoretic device,

controlling the humidity inside the electrophoresis chamber by said humidity-controlling means,

introducing a sample into said channel, and

applying a voltage to said channel to conduct electrophoresis for the sample.

The supply of a sample into the channel and the application of a voltage to the channel can be conducted by using the capillaries having the structure as noted above.

In the electrophoresis method of the present invention, a step of controlling the humidity inside the electrophoresis chamber by the humidity-controlling means to dry the sample may be added, after the electrophoresis for the sample has been conducted.

In the electrophoresis method of the present invention, the electrophoresis of the sample may be applied, while the temperature of the electrophoretic chip is kept at least at the temperature of the humidity-controlling liquid chamber by the above-mentioned temperature-controlling means.

In the electrophoresis method of the present invention, the vaporization of the liquid introduced into the channel can be prevented even when the depth of the channel of the electrophoretic chip is small. As a result, stable electrophoresis can be conducted.

In the electrophoresis method of the present invention, the temperature of the humidity-controlling liquid chamber may be lowered to dry the sample, after the electrophoresis of the sample.

In the electrophoresis method of the present invention, after the completion of electrophoresis of the sample, the temperatures of the electrophoretic chip and the humidity-controlling liquid chamber may be lowered to freeze the sample-containing liquid, while the temperature of the electrophoretic chip is being kept at least at the temperature of the humidity-controlling liquid chamber.

In the electrophoresis method of the present invention, after the freezing of the sample, the temperature of the humidity-controlling liquid chamber may be further reduced to freeze-dry the sample.

In the electrophoresis method of the present invention, a sample frozen or dried on the channel can be obtained in a simple way, after electrophoresis. Thereby, for example, a sample suitable for use in mass spectrometry (e.g. MALDI-MS) can be obtained reliably.

The embodiments of the present invention are described below with reference to the accompanying drawings. In all the drawings, one same symbol was given to common constituent elements and repeated explanation was not made when unnecessary.

### EMBODIMENT 1

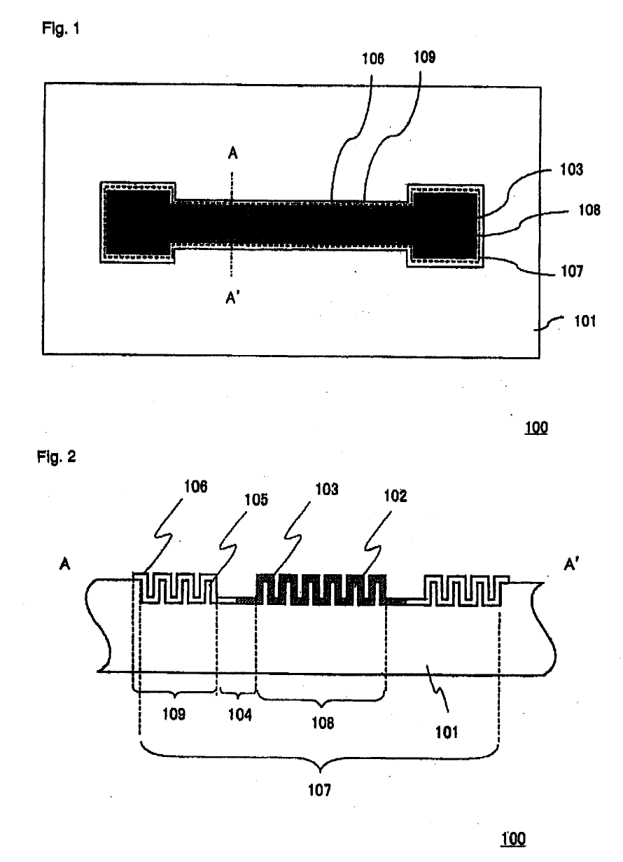

FIG. 1 is a plan view schematically showing the structure of an electrophoretic chip according to the embodiment 1 of the present invention.

FIG. 2 is a sectional view taken at the A-A′ line of FIG. 1. The electrophoretic chip 111 shown in FIG. 1 and FIG. 2 has a substrate 101 and a channel 107 for holding a sample-containing liquid, which is formed on the surface of the substrate 101. The channel is wholly open at the top side of the channel 107. Also, a liquid-keeping part 108 having a first pillar array structure arranged regularly is formed from one end of the channel to other end.

The substrate 101 may be made of, for example, a quartz glass. A resin substrate made of, for example, Teflon (a registered trade name) may be also used. For example, a silicon substrate may be also used, which has an oxide film formed thereon for hydrophilicity and also for electrical insulation.

The channel 107 has a liquid-keeping part 108, a flat part 104 and a lyophobic part 109 from the center of the channel toward the side of the channel in the section perpendicularly intersecting the flow passage of the channel. The liquid-keeping part 108, the flat part 104 and the channel 107 are provided in this order toward outside.

The liquid-keeping part 108 has a first pillar array structure 102 and is formed so as to keep a sample-containing liquid. The surface of the liquid-keeping part 108 is covered with a lyophilic film 103 as a surface coating film. Here, the sample-containing liquid contains a sample (which is a substance to be subjected to electrophoresis) and a predetermined liquid medium. The sample can be present in the liquid medium in various states such as dissolved state, dispersed state and the like as long as the sample can migrate. As the liquid medium, water or a water-containing liquid medium may be mentioned, When the medium is water or a liquid composed mainly of water, a hydrophilic film is used as the above-mentioned lyophilic film. When electrophoresis is conducted for separation of the intended sample, a mixture of two or more kinds of samples is subjected to electrophoresis. When the migration distance of a single sample is measured, a single sample is subjected to electrophoresis. A non-crosslinked polyacrylamide film, etc. can be used as the hydrophilic film; however, the hydrophilic film is not restricted thereto. As a specific example, a hydrophilic film was formed by coating a silane coupling agent (3-methacryloxypropyltrimethoxysilane) as an adhesive; and a polymerizable composition for formation of a hydrophilic film, on the surface of a substrate. The polymerizable composition contained acrylamide, ammonium persulfate as a polymerization agent and TEMED (tetramethylethylenediamine) as a polymerization promoter. The polymerizable composition is then polymerized.

The liquid-keeping part 108 consists of a first pillar array structure 102 arranged regularly, formed on the surface of the substrate 101. The first pillar array structure 102 can have a structure in which a plurality of rows are arranged in parallel. Each row consists of a plurality of the pillar shape structure in the form of a truncated cone or a truncated pyramid having almost the same shape. Each row is arranged along the extending direction of the channel 107. For example, the first pillar array structure 102 may be a pillar array structure arranged regularly, in which a plurality of quadrangular columns are arranged on the substrate 101. These pillar shape structures are arranged in the same direction in a lattice form. In view of the accuracy of pillar array structure formation, “a plurality of truncated cones or pyramids have almost the same shape” means that such cones or pyramids have shapes which are similar to each other in such an extent that the sample-containing liquid makes no leakage from the particular area of the liquid-keeping part 108 and is kept therein. The shape of the pillar shape structure can be, for example, a truncated pyramid, a truncated circular cone or a truncated elliptical cone. The pyramid may be rounded at the edge so as to obtain a smooth curved surface.

In FIG. 2, the height of each pillar shape structure and the depth of the channel are equal. Thereby, the channel 107 and the liquid-keeping part 108 can be formed simultaneously and its easy production is secured.

The surface area of the liquid-keeping part 108 is larger than the channel area where the liquid-keeping part 108 is formed. Also, the liquid-keeping part 108 is made more lyophilic than the channel part having a lyophobic film 106, which is formed at the periphery of the liquid-keeping part 108. Therefore, the channel 107 has a simple structure which is producible easily and stably. The channel further has such a structure that the liquid-keeping part 108 can be made lyophilic selectively and that a sample-containing liquid can be kept therein reliably. When the liquid medium of the sample-containing liquid is water or a liquid composed mainly of water, a hydrophobic film is used as the lyophobic film. The hydrophobic film can be formed by using one of known or commercial materials. As a specific example, there was used a film formed by applying an amorphous fluroplastic [CYTOP (trade name), a product of Asahi Glass Co., Ltd.] by spin coating.

Here, the lyophilicity of the liquid-keeping part 108 can be controlled by controlling the ratio of “the surface area” of the first pillar array structure 102 in the liquid-keeping part 108 to “the channel area”, in which the liquid-keeping part 108 is formed. The liquid-keeping part 108 can be made more lyophilic by enlarging this ratio. As a result, a sample-containing liquid can be kept in the liquid-keeping part 108 selectively. Further, the regular arrangement of the first pillar array structure 102 is made, for example, so that the above surface area ratio becomes larger toward the center of the liquid-keeping part 108. Under such condition, the overflowing of the sample-containing liquid outside the liquid-keeping part 108 can be made more unlikely. The surface area ratio is also a roughness factor α in the Wentzel formula, i.e., the following formula (1). The factor α is a parameter indicating the times of the surface area of pillar array structure to the area of the pillar array structure when it has a flat surface.

cosθr=αcosθ (1)

### The formula (1) holds under the condition of

|αcosθ|<<1.

In the formula (1), θ is the contact angle of a droplet of a target liquid placed on a flat surface made of a material having the same surface condition of the liquid-keeping part 108. Also, θr is the contact angle of the same droplet placed on the liquid-keeping part 108 having the first pillar array structure 102. “Lyophilicity” refers to a state in which the contact angle is at least 0° but smaller than 90°, and “lyophobicity” refers to a state in which the contact angle is larger than 90° but not larger than 180°.

In the liquid-keeping part 108, the ratio of its surface area to its area, which is regarded as a flat surface, is preferred to be large, for example, by making the depth of the first pillar array structure 102 sufficiently large. Thereby, the sample-containing liquid can be reliably kept in the liquid-keeping part 108.

### Also, the above-mentioned α and θ can satisfy the following formula (2).

|αcosθ|>1 (2)

Super lyophilicity or super lyophobicity can be obtained by making the absolute value of αcosθ larger than 1. The liquid-keeping part 108 can be made as an super lyophilic part, by making αcosθ larger than 1 in the liquid-keeping part 108 formed on the surface of a substrate lyophilic to a target sample-containing liquid. As a result, the liquid can be reliably kept in the liquid-keeping part 108 of the first pillar array structure 102. Also, the sample-containing liquid forms no droplet and is filled uniformly in the channel 107.

The flat part 104 is provided so as to surround the periphery of the liquid-keeping part 108 and sandwich the two sides of the liquid-keeping part 108. The flat part 104, unlike the first pillar array structure 102, has no increased surface area resulting from the formation of pillar array structure. Therefore, the flat part 104 has a lower lyophilicity than the liquid-keeping part 108. As to the surface of the flat part 104, its side adjacent to the liquid-keeping part 108 is covered with a lyophilic film 103. Its side adjacent to the lyophobic part 109 is covered with a lyophobic film 106. As a result, the sample-containing liquid can be reliably kept in the liquid-keeping part 108 and its leakage out of the area covered with the lyophilic film 103 can be prevented.

The lyophobic part 109 is provided so as to surround the periphery of the flat part 104 and sandwich the two sides of the flat part 104. The lyophobic part 109 has a second pillar array structure 105 and has a low affinity to the sample-containing liquid. The surface of the lyophobic part 109 is covered with a lyophobic film 106 which is a surface coating film.

The above formula (1) or (2) is applicable also to the lyophobic part 109. The lyophobicity of the lyophobic part 109 can be controlled by controlling the surface area of the second pillar array structure 105. Also, the lyophobic part 109 can be as an made ultra lyophobic part by achieving |αcosθ|>1.

Next, the method for producing the electrophoretic chip 111 is explained. The electrophoretic chip 111 can be obtained by forming a pillar array structure in one process using both the lithography and etching used in micro-processing of the substrate 101. However, since the liquid-keeping part 108 has a first pillar array structure 102, which is special and capable of keeping a sample-containing liquid, it is necessary to form such a pillar array structure on the base late 101. Therefore, such a structure is difficult to obtain simply by roughening the surface of the substrate 101 or simply by forming a plurality of the pillar shape structure on the substrate 101.

In the liquid-keeping part 108, each pillar shape structure is allowed to have a large surface area and is arranged closely therein. As a result, the liquid-keeping part 108 can have an increased surface area and can be made lyophilic sufficiently. Specifically explaining, the structure and arrangement of the pillar shape structure can be made, for example, as follows. The width of each truncated cone or pyramid can be, for example, 0.01 μm to 50 μm. The intervals of the lower surface of each pillar shape structure can be 0.01 μm to 50 μm.

When the electrophoretic chip 111 has been put in the electrophoretic device in a state that electrophoresis can be conducted, its channel 107 is also open at least partially. The liquid-keeping part 108 is formed at least in the vicinity of the open part. The vaporization of the sample-containing liquid from the open part can be prevented by forming the liquid-keeping part 108 at least inside the open part or in the vicinity thereof.

Also, regarding the electrophoretic chip 111, the lower surface and/or at least part of the side of the liquid-keeping part 108 may be made more lyophilic than the upper surface of the first pillar array structure 102, i.e. the upper surface of each pillar shape structure. Also, in the electrophoretic chip 111, the upper surface or at least a part of the side wall of the first pillar array structure 102 (i.e. each pillar shape structure) may be made more lyophobic than the lower part surface of the first pillar array structure 102. Thereby, the risk of flowing of the sample-containing liquid over the upper surface of the liquid-keeping part 108 can be prevented more reliably.

Next, the structure of the electrophoretic device is explained, in which the electrophoretic chip 111 is used. The electrophoretic chip 111 is preferably used in an electrophoresis chamber having a humidity-controlling function. FIG. 3 is a sectional view schematically showing the structure of an electrophoretic device according to the embodiment 1 of the present invention.

The electrophoretic device 110 shown in FIG. 3 has an electrophoretic chip 111 shown in FIG. 1 and FIG. 2; an electrophoresis chamber 118 in which the electrophoretic chip 111 is set; and a humidity-controlling means for controlling the humidity inside the electrophoresis chamber 118. In FIG. 3, a humidity-controlling means, i.e. a humidity-controlling liquid chamber 162, in which a humidity-controlling liquid 117 is installed in the electrophoresis chamber 118.

The electrophoretic chip 111 shown in FIG. 1 and FIG. 2 is placed inside the electrophoresis chamber 118. The electrophoretic chip 111 is placed on a mount 112, and the mount 112 is supported by a supporting plate 114 via a cooling-heating mechanism 113.

A temperature controller 116 controls the temperature of the electrophoretic chip 111. The output of the cooling-heating mechanism 113 is controlled by the temperature controller 116 based on the temperature of the electrophoretic chip 111. The temperature is detected by a thermosensor 115.

The supporting plate 114 is a supporting member for the cooling-heating mechanism 113 and the electrophoretic chip 111 provided above the cooling-heating mechanism 113. The supporting plate further divides the electrophoresis chamber 118 into two upper and lower chambers. Above the supporting plate 114, a chip-installed chamber 163 is installed, in which the electrophoretic chip 111 is set. Below the supporting table 114 is formed a humidity-controlling liquid chamber 162 filled by a humidity-controlling liquid 117. The humidity-controlling liquid 117 is, for example, a liquid medium contained in the sample-containing liquid, or the liquid such as the liquid medium.

Through-holes 161 are formed in the supporting plate 114, and the chip-installed chamber 163 is connected to the humidity-controlling liquid chamber 162. Owing to the formation of the through-holes 161, the atmosphere in the humidity-controlling chamber liquid 162 and the atmosphere in the chip-installed chamber 163 can migrate between the two chambers. Therefore, the saturated vapor generated in the humidity-controlling liquid chamber 162 can be migrated onto the electrophoretic chip 111.

The humidity-controlling liquid chamber 162 is placed above a mount 120 via a cooling-heating mechanism 119. A temperature controller 122 controls the temperature of the humidity-controlling liquid chamber 162. The output of the cooling-heating mechanism 119 is controlled by the temperature controller 122 based on the temperature of the humidity-controlling liquid chamber 162. The temperature is detected by a thermosensor 121.

The outer surface of the electrophoresis chamber 118 is covered by a thermal-insulating container 123 and is thermal-insulated from the outside air. Also, an inner lid 124 and an outer lid 125 are arranged in this order at the top of the electrophoresis chamber 118. The electrophoresis chamber 118 is sealed by these lids. The inner lid 124 and the outer lid 125 can be made of a material (e.g. glass) which is transparent and has a resistance to the operating temperature of the electrophoretic device of the present invention. Thereby, electrophoresis can be conducted reliably and the state of the sample-containing liquid on the electrophoretic chip 111 can be observed from above in the outside. Here, the reason for the use of the double lids is that the presence of a gap between the inner lid 124 and the outer lid 125 can give an increased thermal insulation effect. Thereby, dew condensation on lid and consequent mist on the lid can be prevented.

Capillaries 126 are put so as to pass through the inner lid 124 and the outer lid 125 to set them on the electrophoretic chip 111. In the electrophoretic device 110 shown in FIG. 3, through-holes are formed in the inner lid 124 and the outer lid 125. As a result, the lower end of each capillary 126 is present on the upper surface of the vicinity of each end of the channel. Each capillary is connected to the channel formed in the electrophoretic chip 111 A sample-containing liquid or an electrode solution can be introduced into the channel through the capillary 126. Also, the sample-containing liquid is held inside the capillary 126 which is in contact with the channel. As a result, the liquid height level in the channel 107 can be kept at an intended level. Also, at the time of supplying the electrode solution into the channel, the electrode solution is held inside the capillary in a state that the electrode solution is in contact with the channel; thereby, the contact of the electrode 127 with the electrode liquid can be secured stably by simply inserting an electrode 127 into each capillary 126. The electrode 127 is inserted into the capillary 127 and connected to a power source 128.

Next, the method for operating the electrophoretic device 110 using the electrophoretic chip 111 shown in FIG. 1 and FIG. 2 is explained.

At first, the electrophoretic chip 111 is placed on the mount 112 of the electrophoretic device 110. By operating the temperature controller 116 and the temperature controller 122, the temperature of the electrophoretic chip 111 is set at a temperature at which electrophoresis is conducted. Also, the temperature of the humidity-controlling liquid chamber 162 is preferably controlled to be lower than the temperature of the electrophoretic chip 111. Thereby, excessive condensation of solvent on chip can be prevented. In this case, the temperature difference between the electrophoretic chip 111 and the humidity-controlling liquid chamber 162 is preferably kept to be 2° C. or less. Thereby, the vaporization of the liquid medium from the sample-containing liquid present on the electrophoretic chip 111 can be prevented reliably.

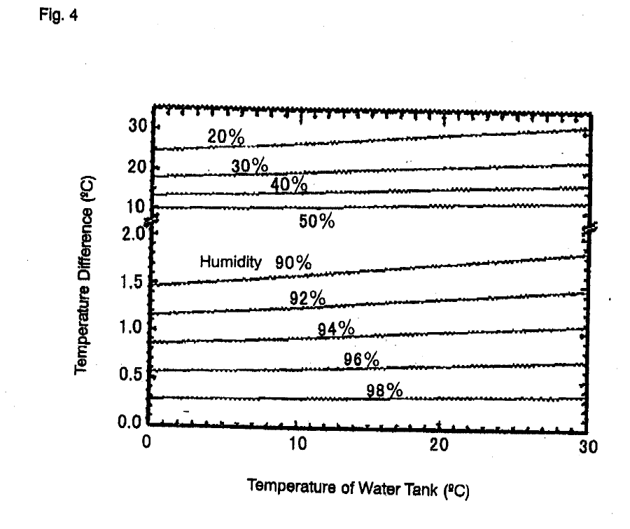

Also, the humidity of the chip-installed chamber 163 is controlled using the humidity-controlling liquid chamber 162. FIG. 4 is a graph showing the humidity change in the chip-installed chamber 163. In FIG. 4, the axis of abscissa is the temperature in the humidity-controlling liquid chamber 162. Also, the axis of ordinate is the temperature difference between the humidity-controlling liquid chamber 162 and the electrophoretic chip 111. The humidity in the humidity-controlling liquid chamber 162 is shown as % in the graph. It is appreciated from FIG. 4 that, the temperature difference between the humidity-controlling liquid chamber 162 and the electrophoretic chip 111 can be controlled and the electrophoretic chip 111 can be kept at an intended temperature, by controlling the humidity and temperature of the humidity-controlling liquid chamber 162. Electrophoresis is conducted ordinarily at a temperature of 0° C. to 10° C. For example, when the temperature difference between the humidity-controlling liquid chamber 162 and the electrophoretic chip 111 is controlled to be 2° C. or less, the humidity in the chip-installed chamber 163 can be controlled to be 90% or more.

When the temperature of the electrophoretic chip 111 has stabilized, a sample-containing liquid is introduced into the channel of the electrophoretic chip 111 from the capillary 126, appropriately depending upon an intended purpose. In this case, since the channel of the electrophoretic chip 111 has a liquid-keeping part 108, the sample-containing liquid is introduced into the channel rapidly and is kept in the liquid-keeping part 108. Since each capillary 126 is connected to the electrophoretic chip 111 having the liquid-keeping part 108, a liquid containing a very small amount of a sample can be introduced into the channel 107 reliably by a simple method. Thus, a predetermined part of the channel can be filled with the liquid uniformly. Then, an electrode solution is introduced into the capillary 126. The electrode solution can be selected depending upon an intended purpose. When the sample is a bio-substance such as protein or the like, a buffer solution ordinarily used in electrophoresis of bio-substance can be used as the electrode solution.

Then, the electrode 127 is inserted into the capillary 126 and then connected to a power source 128. The power source 128 is turned on, a voltage is applied between the two electrodes 127, and electrophoresis is conducted. In this case, it is preferred that electrophoresis is conducted while the temperature of the electrophoretic chip 111 is being kept at least at the temperature of the humidity-controlling liquid chamber 162. Thereby, electrophoresis of the sample introduced into the electrophoretic chip 111 can be conducted stably.

After the completion of the electrophoresis, the temperature controller 122 is controlled in a state that the temperature of the electrophoretic chip 111 is still kept at a given level, and the temperature of the humidity-controlling liquid chamber 162 is reduced. Thereby, the humidity-controlling liquid 117 present in the humidity-controlling liquid chamber 162 is frozen. Then, the temperature controller 116 is controlled so as to lower the temperature of the electrophoretic chip 111 to freeze the sample-containing liquid migrated on the channel. By this freezing treatment, the position of the migrated sample in the channel can be fixed. Also, dew condensation on the surface of the electrophoretic chip 111 can be prevented, by lowering the temperature of the humidity-controlling liquid chamber 162 prior to lowering of the temperature of the electrophoretic chip 111. Since the inside of the liquid-keeping part 108 comprises a plurality of rows each consisting of a plurality of the pillar shape structure arranged regularly, there is a supplementary effect that it becomes difficult that the sample, which was migrated and fixed in the channel, further moves. There is also a supplementary effect that it becomes difficult that the sample migrated in the channel further moves, even when the sample of liquid state is simply heated and dried. There is also a side effect that the sample migrated in the channel moves hardly even when the sample is in a liquid state, because the diffusion of the sample is prevented.

The sample in the channel is freeze-dried by keeping the temperature of the humidity-controlling liquid chamber 162 lower than the temperature of the electrophoretic chip 111. When the rate of drying is small, the inside of the electrophoresis chamber 118 may be evacuated to obtain a vacuum state. When the sample has been dried, the cooling is stopped and the temperature of the electrophoretic chip 111 is returned to room temperature (e.g. about 20° C.). Then, the electrophoretic chip 111 is taken out from the electrophoresis chamber 118.

By the above-mentioned method, electrophoresis using the electrophoretic device 110 shown in FIG. 3 and subsequent drying of the sample after electrophoresis are conducted. Thereafter, the resulting electrophoretic chip 111 may be placed in the holder of a mass spectrometer and analyzed by MALDI-MS. Since a component to be measured is fixed on a particular position of the chip, the whole chip can be used for mass spectrometry. In this case, the matrix for assistance of ionization may be added beforehand into the sample-containing liquid. Also, the matrix may be added by spraying it on the channel after drying of the sample.

Thus, purification of a sample to be provided to an analysis using mass spectrometry (e.g. MALD-MS) can be carried out reliably, by using the electrophoretic chip 111 shown in FIG. 1, in the electrophoretic device 110 shown in FIG. 3. The liquid-keeping part 108 is provided in the electrophoretic chip 111 and the humidity in the humidity-controlling liquid chamber 162 is controlled. As a result, the drying of the sample introduced into the channel 107 is prevented and separation of the component(s) can be conducted reliably, even when the sample amount is very small. Also, when the depth of the channel 107 is small, the vaporization of the liquid solvent in the sample-containing liquid is striking. However, the sample-containing liquid can be kept stably in the channel 107 by using the electrophoretic chip 111 shown in FIG. 1 and FIG. 2. Also, by conducting electrophoresis using the electrophoretic chip 111 and the electrophoresis chamber 110 shown in FIG. 3, the vaporization of the liquid medium from the sample-containing liquid can be prevented more reliably.

Also, the electrophoretic device 110 is simply formed and yet can reliably moderate the temperature rise of the sample-containing liquid, caused by Joule heat. Also, the device 110 is formed so as to enable stable contact of electrode 127 with liquid.

Also, it is possible to conduct electrophoresis stably by controlling the temperature of the electrophoretic chip 111 and the temperature of the humidity-controlling liquid chamber 162 using the cooling-heating mechanism 113 and the cooling-heating mechanism 119. It is also possible to conduct freezing and drying of the separated sample in a state that the separated sample has been kept on the channel, after the separation of the sample by the electrophoresis. Thereby, a sample suitable for MALDI-MS can be prepared reliably.

In the electrophoretic device 110 shown in FIG. 3, the electrophoresis chamber 118 also may be formed so as to be exhausted and connect to exhauster such as vacuum pump or the like. Thereby, in freeze-drying the sample in the channel, rapid drying is possible even when the rate of drying is small at normal pressure. Also, the electrophoresis chamber 118 may be formed so as to enable replacement of the inside atmosphere. For example, when isoelectric focusing is conducted on the electrophoretic chip 111, carbon dioxide in the air dissolves into the liquid, which may make unstable the gradient of hydrogen ion concentration, formed in the channel. In such a case, migration conditions can be stabilized by replacing the atmosphere inside the electrophoresis chamber 118 with, for example, highly inactive, high-purity nitrogen gas.

Also, in the electrophoretic chip 111 shown in FIG. 1 and FIG. 2, the liquid-keeping part 108 may have a structure, in which a plurality of rows are arranged in parallel. Each row consists of a plurality of the pillar shape structure having bout the same shape. Each row is arranged along the extending direction of the channel 107. The length of the sectional contour of the liquid-keeping part 108 per the unit length of the channel 107 in the extending direction of each row is larger than the length of the sectional contour of the liquid-keeping part 108 per the unit length of the channel 107 in other direction nonparallel to the extending direction of each row. The other direction may be, for example, a direction perpendicular to the extending direction of each row. Also, for example, when the section of the liquid-keeping part 108 is like comb teeth, the sectional contour is comb teeth-shaped.

Also, in the electrophoretic chip 111, the first pillar array structure 102 may have a structure in which a plurality of the pillar shape structure is arranged in an oblique lattice shape (e.g. a checkered lattice shape). Also, the structure 102 may be formed so that there is no straight-line groove in a direction perpendicular to the extending direction of the channel 107. Thereby, there is no large change in lyophilicity along the arranged lines. Also, the leakage of the liquid from the liquid-keeping part 108 toward the side of the channel 107 can be prevented more reliably.

### EMBODIMENT 2

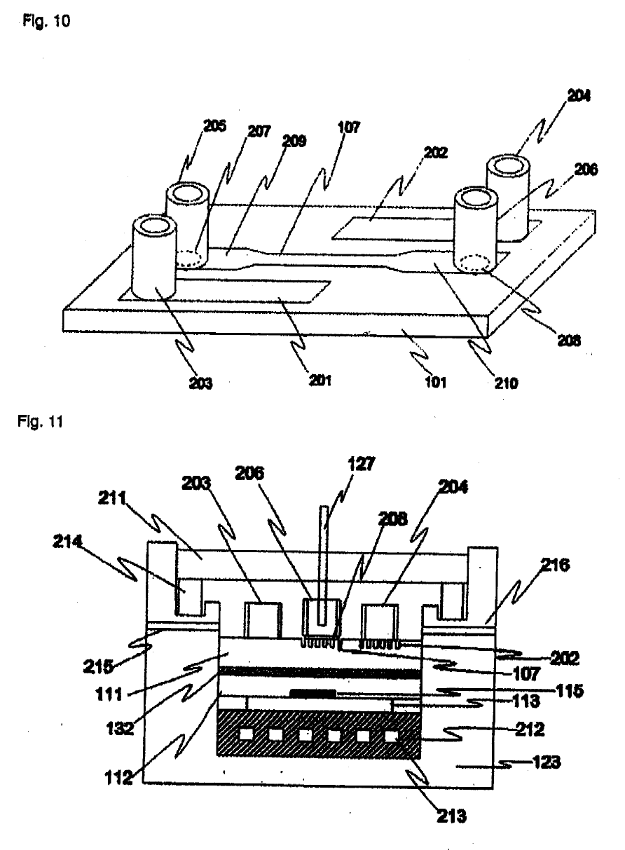

In the present embodiment 2, isoelectric focusing of a protein was conducted using an electrophoretic chip schematically shown in FIG. 10 and an electrophoresis chamber schematically shown in FIG. 11. The present embodiment 2 is different from the embodiment 1 especially in the following points in the embodiment 2.

The reservoirs for vapor pressure control were placed on the chip. The waste heat of the Peltier device in the electrophoresis chamber was treated by liquid cooling. A filter paper impregnated with a pH-fixed polyacrylamide gel was adhered onto the bottom of the reservoirs placed on the chip.

FIG. 10 is a plan view showing the layout of an electrophoretic chip. Three channels 107, 201 and 202 are formed on the chip. Of these, 107 is a channel on which electrophoresis is conducted, and 201 and 202 are channels for vapor pressure control. At each one terminal of the channels 201 and 202 are placed reservoirs 203 and 204 for holding a volatile solvent. The reservoirs 203 and 204 are open at their bottoms. When a solvent is poured thereinto, the solvent flows into the channels 201 and 202. That is, the channels 201 and 202 are formed so as to have a large width (a large area) and enable easy vaporization of the solvent. Meanwhile, at the two ends of the channel 107 are provided reservoirs 205 and 206 so as to enable holding of an electrode solution. Filter papers 207 and 208 are adhered onto the bottoms of the reservoirs 205 and 206 are adhered, as indicated in broken lines. With these filter papers, flow of en electrode solution into the channel 107 can be prevented. It is also desirable that the filter papers 207 and 208 are beforehand impregnated with a polyacrylamide gel whose immobilized pH value has been fixed at an intended value. Slightly wide channel portions 209 and 210 are formed from the reservoirs 205 and 206 toward the channel 107. These portions are provided in order to introduce a solution sample containing a protein, into the channel 107. Introduction of the sample solution into the channel 107 is conducted by dropping the sample onto the channel portions 209 and 210 using, for example, a pipette or a dispenser. The portions 209 and 210 are also provided at the two ends of the channel 107; however, such a portion may be provided only at one end, or a large number of such portions may be provided in the channel. Their provision at the two ends of the channel 107, as compared with the provision only at one end, makes quicker the sample introduction into the channel.

### EXAMPLES

### Example 1

In the present Example, isoelectric focusing of a protein was conducted by using the electrophoretic chip 140 shown in FIG. 5 and FIG. 6, in the electrophoretic device shown in FIG. 9 as an electrophoretic chip 111. The electrophoresis was conducted under the conditions of 3.5 kV voltage application to flow path length of about 60 mm and migration time of 10 minutes. The protein used was lactogloblin or myoglobin. The electrode solution used was cIEF and ampholite, which were attachments to the isoelectric focusing kit of Beckmann Coulter Inc. The fluorescence marker used was a mixture of several kinds of fluorescence IEF markers of SIGMA-ALDRICH Co. These conditions were used also in Example 2 to be described later. These conditions can be selected depending upon the kind of the sample used.

FIG. 5 is a photograph of the top of an electrophoretic chip 140. In the electrophoretic chip 140 shown in FIG. 5, a channel 141 of about 25 cm in length is arranged meanderingly. At the two ends of the meandering channel 140 are provided reservoirs 142 and 143 for storage of an electrode solution. The reservoir 142 is connected to the channel 141 via a bottleneck 144. The reservoir 143 is connected to the channel 141 via a bottleneck 145. By providing the bottlenecks 144 and 145, the diffusion into the channel 141, of the electrode solutions introduced into the reservoirs 142 and 143 can be prevented. In the middle of the channel 141, there is provided a reservoir 146 which communicates with the channel 141 in order to introduce a sample-containing liquid into the channel 141. In the present Example, a protein solution is used as the sample-containing liquid.

FIG. 6 is a sectional view schematically showing the structure of the channel 141 of the electrophoretic chip 140 shown in FIG. 5. FIG. 6 shows a section perpendicular to the extending direction of the channel 141. The structure of the section shown in FIG. 6 is basically the same as the structure of the section shown in FIG. 2, but is different in that the outer surface of the substrate 101 was made hydrophobic for use as a lyophobic part 109. Also, in the present Example, a quartz glass substrate having electrical insulation was used as the substrate 101. Also, in the present Example, fluorescence reflected from the back surface of the substrate 101 is also used for observation of protein migration during isoelectric focusing by using a fluorescence microscope. Therefore, a thin gold layer 148 was formed at the bottom of the substrate 101, via a thin titanium layer 147 for higher adhesively.

In the area in which the channel 141 was formed, a liquid-keeping part 108 consisting of a first pillar array structure 102, a flat part 104 and a lyophobic part 109 were formed, in this order, from the center of the channel 141 toward outside. The first pillar array structure 102 and the flat part 104 were formed by dry-etching the substrate 101. A polyacrylamide film was formed as a lyophilic film 103 on the surface of the first pillar array structure 102, as well as on the surface of the portion of the flat part 104, adjacent to the first pillar array structure 102. Also, a fluororesin film was formed as a lyophobic film 106 on the surface of the portion of the flat part 104, adjacent to the lyophobic part 109. The film was formed also on the surface of the portion (to become a lyophobic part 109) of the substrate 101, surrounding the flat part 104. In the first pillar array structure 102, the height was 4 μm, the width of channel 141 shown in the section of FIG. 6 was 2.5 μm, and the gap was 2.5 μm.

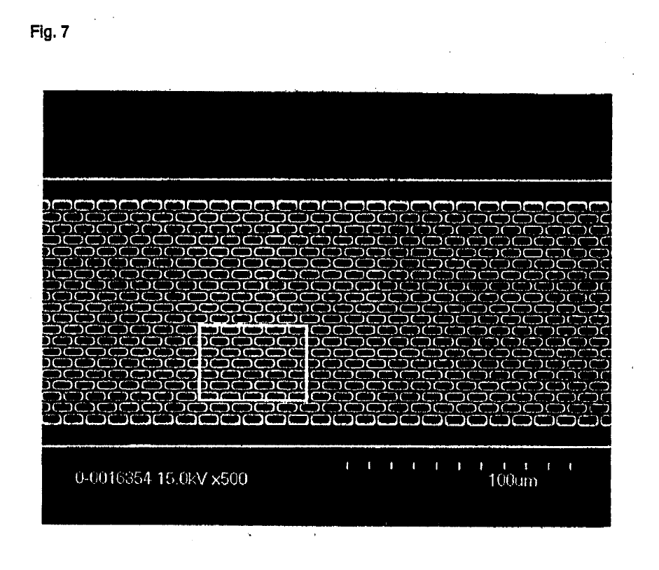

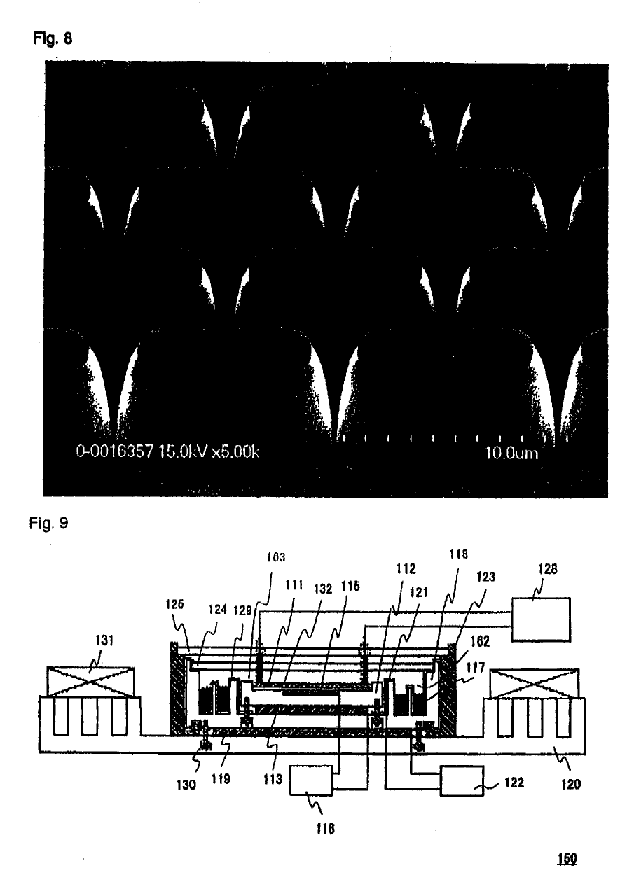

FIG. 7 and FIG. 8 are each a photograph of the channel 141 of the electrophoretic chip 140 obtained, which was taken by a scanning type electron microscope (SEM). FIG. 7 is a top view of the channel 141, and FIG. 8 is a perspective view obtained by enlarging an area of FIG. 7 surrounded by a quadrilateral. As shown in FIG. 7 and FIG. 8, the length of the edge line of the first pillar array structure per the unit length of the channel 141 in the extending direction of the channel 141. Therefore, the length of the sectional contour was made larger than the length of the sectional contour of the first pillar array structure 102 per the unit length of the channel 141 in the direction perpendicular to the extending direction of the channel 141.

Also, pillar shape structures were arranged in a checkered lattice shape. Thus, the portions between each two pillar shape structures adjacent to each other in the crosswise direction of the channel 141 were arranged in a zigzag shape and not in a straight line. The sectional contour of the first pillar array structure 102 in the extending direction of the channel 141 was enlarged, and a plurality of the pillar shape structures in an oblique lattice shape was arranged. As a result, the introduction of the sample solution into the channel was smooth and there was no leakage of the sample solution from the side of the channel 141. This chip was placed in an electrophoresis chamber shown in FIG. 9.

FIG. 9 is a sectional view schematically showing the structure of the electrophoretic device used in the present Example. The basic structure of the electrophoretic device 150 shown in FIG. 9 was the same as the electrophoretic device 110 shown in FIG. 3. However, a humidity-controlling liquid chamber 162 was provided so as to surround the side of a chip-installed chamber 163. In the electrophoretic chip 150, the electrophoretic chip 140 shown in FIGS. 5 to 8 was used as the electrophoretic chip 111. Also, the materials for a mount 112 and an electrophoresis chamber 118 were both aluminum. Also, a part of each surface of the mount 112 and the electrophoresis chamber 118 was covered with a fluororesin coating 129 for prevention from staining.

Also, a heat-conductive gel sheet 132 was set on the mount 112, and the electrophoretic chip 111 was set on the heat-conductive gel sheet 132. By using the heat-conductive gel sheet 132, the electrophoretic chip 111 can be supported in a state that good heat conductivity is kept. There was used a heat-insulating container 123 made of a fluororesin.

An inner lid 124, an outer lid 125 and capillaries 126 were made of a quartz glass. Thereby, the electrophoretic chip 11 can be observed easily. A platinum resistor for temperature measurement was used as a thermosensor 121 and a thermosensor 115. Also, A Peltier device was used as a cooling-heating mechanism 113 and a cooling-heating mechanism 119. Pure water was used as a humidity-controlling liquid 117.

The electrophoresis chamber 118 whose circumference was covered with a heat-insulating container 123, was fixed by screws 130, on an aluminum-made mount 120 for acceptance of a waste heat conducted from the Peltier device (the cooling-heating mechanism 119). All the screws 130 were made of a highly heat-insulating resin. The mount 120 has fins for heat radiation. A fan(s) 131 was fined on the fins.

In the present Example, air cooling using the fins and the fan was also employed. However, other heat radiation method such as water cooling or the like may be used.

In the present Example, the thus-obtained electrophoretic device 150 was connected to a fluorescence microscope. Then, isoelectric focusing of a protein was conducted and its proceeding was observed.

The temperature of the electrophoretic chip 140, i.e. the electrophoretic chip 111 in FIG. 9 was set at 10° C. using a temperature controller 116. Also, the temperature of the humidity-controlling liquid chamber 162 was set at 9.8° C. using a temperature controller 122. After these temperatures had stabilized, first, a mixed solution was introduced as a sample solution into a channel 141 from a reservoir 146 for introduction of protein solution, via the capillary 126. The mixed solution comprises the capillary isoelectric focusing (cIEF) gel and ampholite contained in cIEF kit produced by Beckmann Coulter Co., a matrix for assistance of protein ionization during mass spectrometry, and a lactogloblin marked with a fluorescent dye capable of forming a covalent bond with the lactogloblin.

After the channel 141 had been uniformly filled with the protein solution, an electrode solution for anode and an electrode solution for cathode were introduced, respectively, into a reservoir 142 and a reservoir 103, via each capillary 126. Then, a platinum electrode was inserted into each capillary 126, and a voltage of about 10 kV was applied to the electrodes 127 from a power source 128. After 4 minutes from the electrification, a fluorescent spot of a protein was observed using the fluorescence digital imaging microscope. A protein spot was confirmed at a particular site of the channel 141.

Then, in the present Example, first, the humidity-controlling liquid 117, i.e. pure water in the humidity-controlling liquid chamber 162 was frozen. Next, the protein solution on the electrophoretic chip 140 was frozen. The inner lid 124 and the outer lid 125 were removed and the electrophoretic chip 140 was heated, whereby the solvent in the protein solution vaporized and dried without collapse of the spot on the channel 141. Thus, when the liquid-keeping part has pillar shape structures, the migration of liquid is prevented during freezing or drying, and the freezing or drying without crumbling of separated spot becomes possible. Thus, in the present Example, a dried sample separated by electrophoresis was obtained on the electrophoretic chip 140. An ionization-promoting agent was added, by spraying, to the obtained sample kept on the channel 141, after which the sample could be analyzed by MALDI-MS.

### Example 2

An electrophoretic chip shown in FIG. 10 was placed in an electrophoresis chamber, as shown in FIG. 11, and measurement was made. Reservoirs 203, 204, 205 and 206 are fixed in the electrophoresis chamber using a fixing plate not shown in FIG. 11. Each electrode 127 can be fixed by various methods but, for example, is inserted into the reservoir 206 through a glass lid 211. The same applies in the case of the reservoir 205. The chip 111 is fixed on a mount 112 via a heat-conductive gel sheet 132. Since a voltage of several kVs is applied between the electrodes during isoelectric focusing, it is preferred to produce the mount 112 with a heat-conductive ceramic of good electrical insulation, such as aluminum nitride [e.g. Shapal (trade name) or Shapal M (trade name)]. A thermosensor is provided beneath the supporting table. For measurement of chip temperature at good precision, it is preferred to provide the thermosensor 115 at a position as close as possible to the chip 111, for example, beneath the chip 111. However, it is preferred to set the thermosensor 115 beneath the mount 112 of good electrical insulation for prevention of collapse of the thermosensor 115 by leakage occurring when a high voltage has been applied. A Peltier device 113 and the reservoirs 203 and 204 for humidity control were set beneath the mount 112. This Peltier device has functions as a cooling-heating device for control of the temperatures of the chip 111. The Peltier device 113 may be small as long as it has a sufficient ability for cooling and heating. The surface uniformity of chip with respect to its heating and cooling is secured by using a material of good heat conductivity for the mount 112. A cooling plate 212 for liquid cooling is set for the treatment of the waste heat of the Peltier device 113. The cooling plate 212 for liquid cooling has holes (through-holes) 213 for cooling liquid-circulating pipe. A cooling liquid sent from a chiller is circulated through the holes 213, whereby the above-mentioned waste heat can be treated. Therefore, the cooling plate 212 for liquid cooling is preferred to be made of a good heat conductor such as aluminum or copper. Preferably, the surface of aluminum is subjected to an oxidation treatment in order to improve the corrosion resistance. As the cooling liquid, there can be used water, Nalbrine (trade name), etc. Desirably, for example, a paste (e.g. heat-conductive grease) is coated for improvement of surface roughness and consequent higher thermal contact, between the cooling plate 212 for liquid cooling and the Peltier device 113 or on the interface between the Peltier device 113 and the mount 112. As shown in FIG. 11, all of these are covered with a heat-insulating container 123 and a glass lid 211 with a packing 214 being interposed between them. Thereby, a closed space is formed inside the heat-insulating container 123. As the material for the heat-insulating container 123, for example, Teflon is desirable, which is low in heat conductivity, good in electrical insulation and superior in chemical resistance. It is desired to install a gas outlet 215 and a gas inlet 216 in order to degas the inside of the heat-insulating container 123 or replace the gas therein. It is also desired to provide a valve very near each one end of the gas outlet 215 and the gas inlet 216, which is in contact with the outer wall of the heat-insulating container 123. The valves are provided in order to attain high heat insulation from the outside of the heat-insulating container and control the vapor pressure inside the closed space at a high precision.

Next, the operating procedure of the electrophoretic chip and the electrophoresis chamber is explained. At first, the electrophoretic chip 111 is set in the electrophoresis chamber, as shown in FIG. 11. Then, a cooling liquid sent from the chiller is circulated through the holes 213 to set the temperature of the cooling plate 212 at a desired level. Then, the Peltier device 113 is connected to a temperature controller to start its operation and set the temperature of the thermosensor 115 at an intended level. When the temperature of the chip has reached an intended level (for example, 10° C. which is ordinarily used in isoelectric focusing), a solvent alone placed in the reservoirs 203 and 204 for humidity control is allowed to spread into the channel 201 and 202 and is vaporized. Then, the humidity inside the electrophoresis chamber is enhanced. In the case of the present embodiment 2, since the channels 201 and 202 to supply the vapor of the solvent, are present on the chip, precise control of humidity is difficult; for example, it is difficult to attain a humidity which is as high as possible and causes no dew condensation. However, there is a merit of easy operation, by using a supply source of solvent vapor as a disposable product on the chip, even if the supply source is stained easily and its care is difficult. Further, since no transportation of liquid is necessary between the inside and the outside after the lid has been put, a closed state for degassing can be formed easily. After the formation of the closed structure, the gas inside the closed space can be replaced, for example, by sending an inert gas from the gas inlet 216 and conduct degassing from the gas outlet 215. As a result, the dissolution of carbon dioxide of the air into the solution and its harmful influence on the formation of hydrogen ion concentration gradient are also prevented. In this case, by conducting the gas replacement at a rate sufficiently smaller than the rate of vaporization of the solvent from the channels 201 and 202, the gas replacement can be conducted with no change in humidity. In a state that a sufficiently high humidity has been achieved, a solution is first introduced, from 209 and 210 on the chip by dropping with a pipette. The solution contains an amphoteric carrier (e.g. a peptide, a polypeptide or a protein to be subjected to separation under its isoelectric point) and, as in Example 1, a cIEF gel and ampholite. After the dropping, the super hydrophilic channel 107 is filled with the solution quickly. The filter papers 207 and 208 in the dried state are then impregnated with a pH-fixed polyacrylamide gel to contain the solvent of the solution and becomes functional as a salt bridge. In this state, an acid or alkali electrode solution is introduced into each of the reservoirs 205 and 206. Flow of the electrode solution into the channel 107 can be prevented by the filter papers 207 and 208. Further, although the electrolytic solution has no accurate reproducibility of pH level, it is compensated by the effect of the pH-fixing gel. As a result, thereby the hydrogen ion concentrations at the two ends of the channel 107 can be realized at a good reproducibility. Thus, as a result, the hydrogen ion concentration gradient produced at the time of voltage application can be stabilized. After the introduction of the electrode solution, the glass lid 211 is placed, the container 123 is sealed, and a platinum electrode 127 is inserted into the reservoir 206. Another electrode is inserted as well into the reservoir 205 not shown in FIG. 11. A high voltage is applied between the electrodes by using the acid side as a positive pole and the alkali side as a negative pole, to generate a hydrogen ion concentration gradient and separate the amphoteric carrier. Then, by using the Peltier device 113, the solution after separation may be frozen and may be further heated for solvent evaporation and drying. During the heating and drying, when there are pillar shape structures in the channel 107, migration of solution is prevented and the drying can be conducted without corruption of the pattern of amphoteric carrier after separation. When freezing is conducted, degassing and subsequent freeze-drying makes possible, as well, drying without corruption of the pattern of amphoteric carrier after separation. Then, an ionization-promoting agent is sprayed, or added appropriately using a dispenser, and the amphoteric carrier can be detected using a mass spectroscope.

1. An electrophoretic chip characterized by comprising a substrate and a channel formed, on the substrate, for electrophoresis of a sample;
said channel having an open part, the top part of which is open or uncovered, and a liquid-keeping part on the bottom part of the channel, on which bottom part a large number of pillars are arranged regularly;
said liquid-keeping part being formed in the open part, the open state of which is maintained during electrophoresis in a electrophoresis chamber or near the open part.

2. An electrophoretic chip according to claim 1, wherein said liquid-keeping part is formed from a vicinity of one end of the channel to the vicinity of the other end.

3. An electrophoretic chip according to claim 1 or 2, wherein said liquid-keeping part is formed so that the product αcosθ of the ratio a of the surface area of the liquid-keeping part to the area occupied by the liquid-keeping part and the contact angle θ of a sample-containing liquid to the flat area at the bottom of the channel satisfies |αcosθ|>1.

4. An electrophoretic chip according to any one of claims 1 to 3, wherein said liquid-keeping part has a structure in which a plurality of rows are arranged in parallel and each row consists of a plurality of truncated cones or pyramids, as the pillars, having almost the same shape and arranged regularly along the extending direction of the channel.

5. An electrophoretic chip according to claim 4, wherein a height of the pillars and a depth of the channel are almost equal.

6. An electrophoretic chip according to claim 4 or 5, wherein a lower surface of the liquid-keeping part or at least part of the side of the liquid-keeping part is made more lyophilic than an upper surface of each pillar.

7. An electrophoretic chip according to any one of claims 4 to 6, wherein an upper surface of each pillar or at least part of the side of each pillar is made more lyophobic than a lower surface of the liquid-keeping part.

8. An electrophoretic chip according to any one of claims 1 to 7, wherein a lyophobic part having a large number of projections is provided adjacent to the liquid-keeping part of the bottom of the channel.

9. An electrophoretic chip according to any one of claims 3 to 7, which has a flat part surrounding the periphery of the liquid-keeping part.

10. An electrophoretic chip according to claim 8, wherein the lyophobic part is adjacent to the liquid-keeping part via a flat part.

11. An electrophoretic chip according to any one of claims 1 to 10, characterized by being used in an electrophoresis chamber having a humidity-controlling function.

12. An electrophoretic device characterized by having an electrophoresis chamber in which an electrophoretic chip set forth in any one of claims 1 to 11 is accommodated and a humidity-controlling means for controlling the humidity inside the electrophoresis chamber.

13. An electrophoretic device according to claim 12, wherein said humidity-controlling means has a humidity-controlling liquid chamber which is provided inside the electrophoresis chamber and which holds a humidity-controlling liquid.

14. An electrophoretic device according to claim 13, which has temperature-controlling means for controlling the temperature of the electrophoretic chip and the temperature of the humidity-controlling liquid chamber.

15. An electrophoretic device according to any one of claims 12 to 14, which has capillaries for supplying a sample to the channel, the capillaries having a structure enabling insertion of electrodes thereinto for application of a voltage to the channel.

16. An electrophoresis method for conducting electrophoresis for a sample using an electrophoretic device set forth in any one of claims 12 to 15, characterized by comprising the steps:
placing said electrophoretic chip in the electrophoresis chamber of said electrophoretic device,
controlling the humidity inside the electrophoresis chamber by said humidity-controlling means,
introducing a sample into said channel, and
applying a voltage to said channel to conduct electrophoresis for the sample.

17. An electrophoresis method according to claim 16, wherein the introduction of the sample into the channel is conducted by using capillaries set forth in claim 15 and the voltage application to the channel is conducted via the electrodes inserted into the channel.

18. An electrophoresis method according to claim 16 or 17, wherein, after the electrophoresis has been conducted, a humidity inside the electrophoresis chamber is controlled by the humidity-controlling means to dry the sample in the channel.

19. An electrophoresis method according to any one of claims 16 to 18, wherein the electrophoresis is conducted while a temperature of the electrophoretic chip is kept at least at the temperature of the humidity-controlling liquid chamber by the temperature-controlling means.

20. A method of using an electrophoretic device according to any one of claims 16 to 19, wherein, after the electrophoresis has been conducted, a temperature of the humidity-controlling liquid chamber is lowered to dry the sample.

21. An electrophoresis method according to any one of claims 16 to 20, wherein, after the electrophoresis has been conducted, temperatures of the electrophoretic chip and the humidity-controlling liquid chamber are lowered while the temperature of the electrophoretic chip is controlled at least at the temperature of the humidity-controlling liquid chamber, to freeze the sample.

22. A method of using an electrophoretic device according to claim 21, wherein, after the sample has been frozen, the temperature of the humidity-controlling liquid chamber is lowered further to freeze-dry the sample.
